(19) United States
(12) Patent Application Publication
(10) Pub. No.: US 2026/0310591 A1
(43) Pub. Date: Oct. 8, 2026

(54) TEST SELECTION TECHNIQUES

(71) Applicant: Dell Products L.P., Hopkinton, MA (US)

(72) Inventors: Vamsi K. Vankamamidi, Hopkinton, MA (US); Sihang Xia, Beijing (CN); Geng Han, Beijing (CN)

(73) Assignee: Dell Products L.P., Hopkinton, MA (US)

(21) Appl. No.: 19/172,005

(22) Filed: Apr. 7, 2025

(51) Int. Cl. G06F 11/3668

(52) U.S. Cl. CPC G06F 11/3688; G06F 11/3676; G06F 11/3684

(57) ABSTRACT

Techniques can include: receiving source code changes to first functions; cross referencing the first functions with a footprint to identify a first test set; determining a region of code based, at least in part, on the source code changes; determining other source code changes that modify one or more lines of code included in the region of code; determining a second test set based on the other source code changes, where the second test set includes a second portion of tests, wherein each test of the second portion when executed on one or more platforms failed prior to making a corresponding one or more of the other source code changes; determining a final set based on the first the second test sets; and testing the source code changes by executing the final set using a first version of a software product including the first source code changes.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY OF THE PRESENT DISCLOSURE

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: receiving first source code changes that modify first functions, wherein the first functions are included a plurality of functions; cross referencing the first functions with a footprint to identify a first test set, wherein the footprint indicates which of the plurality of functions are executed by each test of a plurality of tests when said each test is executed on a plurality of platforms, wherein the first test set includes a first portion of the plurality of tests, and wherein each test of the first portion, when executed on one or more of the plurality of platforms, executes at least one function included in the first functions; determining a region of code based, at least in part, on the first source code changes; determining other source code changes that modify one or more lines of code included in the region of code; determining a second test set based, at least in part, on the other source code changes, where the second test set includes a second portion of the plurality of tests, and wherein each test of the second portion when executed on one or more of the plurality of platforms failed prior to making a corresponding one or more of the other source code changes; determining a final test set based on the first test set and the second test set; and testing the first source code changes by executing the final test set using a first version of a software product including the first source code changes.

In at least one embodiment, the footprint can includes a table, wherein each column of the table corresponds to one of the plurality of functions, wherein each row of the table corresponds to one of the plurality of tests, and wherein each entry of the table includes a vector with a plurality of vector entries each corresponding to one of the plurality of platforms. A vector entry of the vector of said each entry of the table can include a non-zero value if a corresponding test executed on a corresponding platform executed code of a corresponding function, and wherein the corresponding test and the corresponding function can correspond uniquely to said each entry of the table including the vector. The non-zero value can denote a count of the number of times the corresponding function is called when executing the corresponding test on the corresponding platform. A vector entry of the vector of said each entry of the table can include a zero value if a corresponding test executed on a corresponding platform did not execute code of a corresponding function, and wherein the corresponding test and the corresponding function correspond uniquely to said each entry of the table including the vector.

In at least one embodiment, the software product can include software of a data path used to process I/O operations received at a data storage system. The first source code changes can be included in a first request to merge the first source code changes with a main version of the software product. Processing can include: determining whether all tests of the final test set executed successfully; and responsive to determining that all tests of the final test set executed successfully against the first version of the software product, merging the first source code changes with the main version of the software product.

In at least one embodiment, the first source code changes can modify a first set of lines of code, wherein the region of code can include the first set of lines of code. The region of code can further include a window of code based, at least in part, on one or more lines of code of the first set. The window of code can include a specified number of consecutive lines of code which are i) prior to the one or more lines of code, and ii) contiguous with the one or more lines of code in any of a source file or a same function. The window of code can include a specified number of consecutive lines of code which are i) after the one or more lines of code, and ii) contiguous with the one or more lines of code in any of a source file or a same function.

In at least one embodiment, the other source code changes can be associated with respective ticket identifiers corresponding to source code changes made to correct software errors. Processing can include: executing each of the plurality of tests each on each of the plurality of platforms; obtaining first coverage information based, at least in part, on the said executing, wherein the first coverage information includes information identifying, for each of the plurality of tests executed on each of the plurality of platforms, which of the plurality of functions is called as a result of executing said each test on said each platform; and generating the footprint based, at least in part, the first coverage information. The region of code can be expressed using source code files and source code file line numbers, and wherein the other source code changes can also be expressed using source code files and source code file line numbers. The region of code can be expressed using functions and function line numbers, and wherein the other source code changes can also be expressed using functions and function line numbers.

### BRIEF DESCRIPTION OF THE DRAWINGS

Features and advantages of the present disclosure will become more apparent from the following detailed description of exemplary embodiments thereof taken in conjunction with the accompanying drawings in which:

FIGS. 1 and 2 are examples of components that can be included in systems in accordance with the techniques of the present disclosure.

FIG. 3A is an example of a function to test footprint that can be used in at least one embodiment in accordance with the techniques of the present disclosure.

FIG. 4 is an example of a request and a ticket database that can be used in at least one embodiment in accordance with the techniques of the present disclosure.

FIG. 5 is an example of catalogues of ticket IDs that can be used in at least one embodiment in accordance with the techniques of the present disclosure.

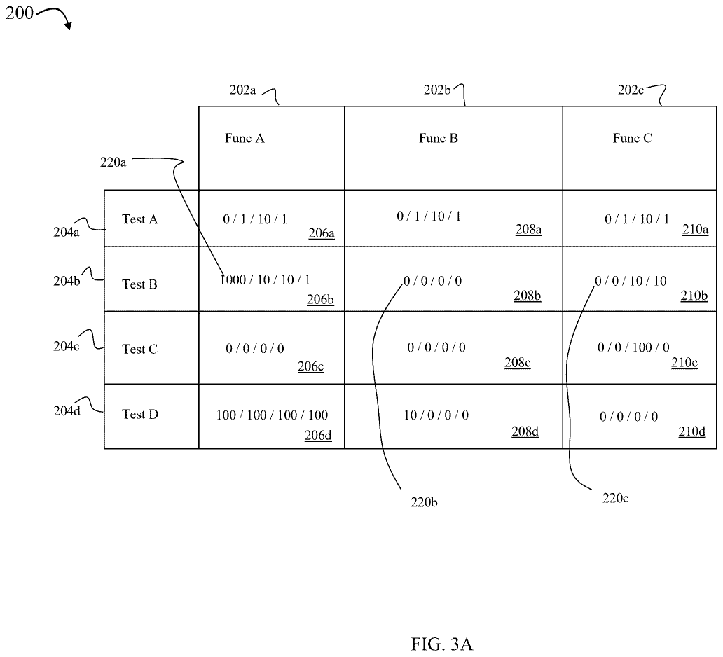

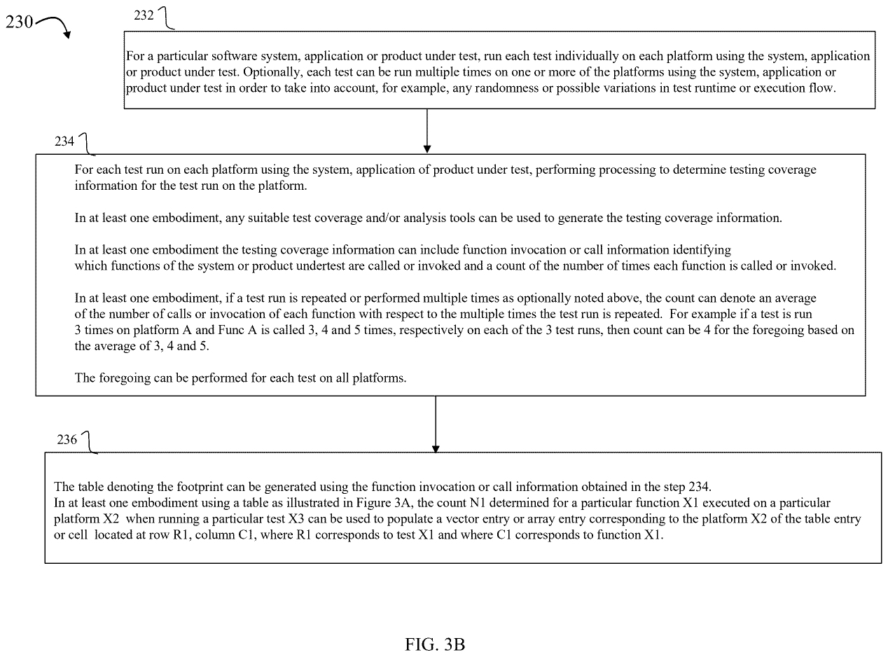

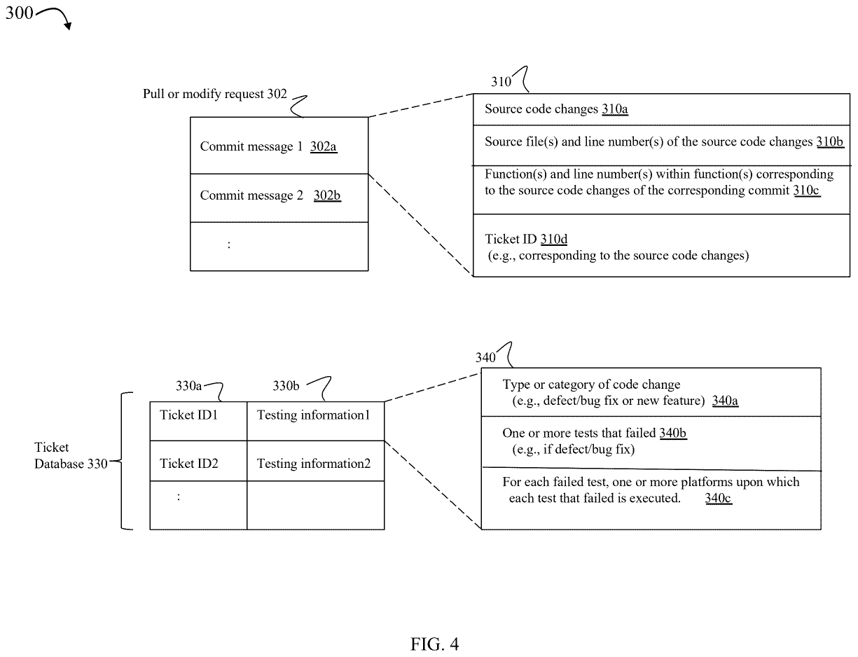

FIGS. 3B and 6 are flowcharts of processing steps that can be performed in at least one embodiment in accordance with the techniques of the present disclosure.

### DETAILED DESCRIPTION OF EMBODIMENT(S)

In a data storage system or more generally any suitable system, source code changes can be made for various development purposes such as, for example, i) implementation of new features and/or ii) correction of software bugs, errors, and/or unexpected runtime behaviors. The source code changes can generally be made to any software system, product or application. For example in at least one embodiment for a data storage system, the source code changes can be made to software components of a data path of I/O path that services I/Os received from data storage clients.

In connection with the source code changes, testing can be performed as part of validating or verifying the source code changes. One problem that exists is determining or selecting the particular tests to be executed as part of sufficiently, efficiently and optimally validating or verifying the source code changes.

The number of tests can drastically increase over time with each software release of a system, product or application. Additionally, the number of tests can increase over time due to the number of platform variants of various features and code modules. Put another way in at least one embodiment, a single code base can support multiple platforms. Thus for the code changes made, testing can be performed across all applicable platforms to ensure full testing coverage.

It may not generally be practical or feasible to run all tests with each set of code changes, where such code changes can be associated with a pull or merge request. A pull or merge request can more generally be characterized as a request to merge a set of developer code changes made to one or more source code modules, routines or files with a master, main code version, or main set of code modules, routines or files. However, before merging any code changes, such as of a pull or merge request, with a main version of code, it can be important to ensure that the main version of code maintains a high level of quality such as by ensuring that such code changes of the pull or merge request i) do not introduce new errors or bugs such as by regression; and ii) correct any bugs or errors which are assumed corrected or addressed by the code changes.

Rather than run all tests available for each pull or merge request, one strategy can include running a small, fixed suite of tests for small code deliveries or a small amount of code changes, and running a larger or full suite of tests for larger scale deliveries such as for new features that can typically involve larger amounts of code changes. However, running the small, fixed suite may not guarantee optimal or sufficient test coverage due to the limited number of tests. Running the full suite may provide sufficient optimal test coverage but can be less efficient in that even tests irrelevant or not impacted by a code change are also executed.

Accordingly, the techniques of the present disclosure can be utilized in at least one embodiment to select relevant tests based, at least in part, on the particular source code changes. The techniques of the present disclosure can be utilized to provide optimized test coverage based, at least in part, on the source code changes. In at least one embodiment, the techniques of the present disclosure can improve the efficiency of testing and development by excluding tests determined as not relevant to the code change.

In at least one embodiment, the techniques of the present disclosure can be utilized in connection with selecting relevant tests to be executed based, at least in part, on the code changes of a pull request. A pull request can more generally be characterized as a request to merge a set of developer code changes made to one or more source code modules, routines or files with a master, main code version, or main set of code modules, routines or files. The set of developer code changes can include, for example, first code changes made to first routines. The pull request can be more generally also referred to as a merge request to merge the first code changes with an existing code base that can include the first routines as well as other routines. Often, a single developer can make the first code changes, for example, in connection with the single developer's individual task for code development and implementation of a new feature, software bug correction, and the like. With source code control systems or SCSs, the single developer can make such first code changes to a copy of the first routines that can be included in a developer's code branch or version including the first routines and any additional code of the product or system that can be used in connection with the first routines. Thus the first code changes can be included in a developer's local code branch or version.

The single developer can then request that their first code changes of the developer's code version or branch be checked into and merged or integrated with an existing code base such as of main code version or branch. The main code version or branch can be used by other developers so that by merging the first code changes into the main code version, the first code changes are incorporated into an updated main code version accessible to the other developers for further changes. Prior to checking in the first code changes in the SCS and merging the first code changes with the existing code base, a pre-checkin qualification can be performed on the first code changes to the first routines. The pre-checkin qualification can include performing testing based on the first code changes. Such testing can include running tests on the developer's code version or branch of a product or system including the first code changes along with other code of the product or system needed to execute the tests.

The pre-checkin qualification can generally be performed to validate or verify the correctness of the first code changes and/or validate or verify that the first code changes do not result in regression or introduction of any additional bugs or failures adversely impacting existing functionality of the product or system. For example, the first code changes can be made to correct a software bug. The software bug can be, for example, improper, incorrect or unexpected runtime behavior such as may be the result of coding and/or design errors. The first code changes can be implemented to correct relevant coding and/or design errors such that the first code changes result in replacing the unexpected runtime behavior or incorrect result with expected proper runtime behavior and/or a correct result. Prior to checking in the first code changes and merging them with an existing code base, testing can be performed using the techniques of the present disclosure regarding the first code changes to validate or verify i) that the first code changes actually correct the software bug, and ii) that the first code changes do not introduce an additional software bug such as, for example, additional unexpected runtime behavior in connection with other code portions of the product. Thus in at least one embodiment, the techniques of the present disclosure can be used to select relevant tests providing optimized test coverage for the first code changes of the pre-checkin qualification prior to merging the first code changes with the main code version or existing code base. In at least one embodiment, the techniques of the present disclosure can improve the efficiency of development and testing by excluding tests determined not to be relevant to the first code changes.

In at least one embodiment, the techniques of the present disclosure can generate and use a test-to-function footprint (sometimes simply referred to as a footprint). In at least one embodiment, the foregoing footprint can be implemented as a table where each row represents a test, each column represents a function, and each cell or table entry can include a vector or array of values denoting function hits during a test run on multiple platforms. In at least one embodiment, a function hit can be a count of the number times a particular function is called or invoked to thereby result in its code being executed when running a particular test such as on a particular platform. Each platform can have a corresponding vector entry in each vector or array of values, where the corresponding vector entry of a footprint table entry can denote whether and/or how many times a particular function is invoked, called and/or executed on a particular platform during a test run for a particular test. In at least one embodiment, each platform can correspond to a different supported hardware and/or software platform or configuration upon which the software application or product being tested can run. In at least one embodiment for a data storage system, each platform can denote a different storage system platform, type, architecture and/or model with varying hardware and/or software and varying capabilities and services. In at least one embodiment, the footprint can be used to determine what particular set of tests are impacted and relevant to a particular function, where the set of tests determined as relevant can be executed when changes are made to corresponding particular function.

In at least one embodiment, generating the footprint can include: i) running each test individually on each platform; ii) generating coverage information including identifying which functions are executed while running each test individually on each platform; and iii) encoding the coverage information denoting the number of times each function is invoked across multiple platforms in corresponding vectors or arrays of the footprint.

In at least one embodiment, the techniques of the present disclosure can include selecting tests for given code changes based, at least in part, on the footprint and the particular functions that are modified such as for a pull or modify request. In at least one embodiment, processing can include identifying the modified functions and cross-referencing the modified functions with the footprint. In at least one embodiment, a test can be determined as relevant to a function, such as when the function is changed or modified, when a corresponding vector or array of the footprint is non-zero thereby having at least one vector or array entry denoting a hit for at least one platform.

In at least one embodiment, the techniques of the present disclosure can include selecting tests for given code changes for a current bug fix or software correction based, at least in part, on i) the particular functions modified for the current bug fix; ii) the particular lines of source code which are modified in the functions for the current bug fix; and iii) a history of related bugs, corresponding bug fixes or software corrections, and corresponding tests that failed in connection with such related bugs. In at least one embodiment, the tests selected can include the corresponding tests that failed previously in connection with related bugs.

In at least one embodiment, the history of related or corresponding bug fixes or corrections can include a code modification to at least one of the same particular lines of source code corresponding to, or also modified for, the current bug fix.

In at least one embodiment, the history of related or corresponding bug fixes or corrections can include a code modification within a defined area or region of code determined with respect to the particular lines of source code corresponding to, or also modified for, the current bug fix. For example, the current bug fix can include modifications to a set of one or more source code lines of a routine or function. In at least one embodiment, the defined area or region can include the set source code lines modified as well as a specified number of source code lines before and/or after each of the modified source code lines of the routine or function. For example in at least one embodiment, the current bug fix can include modifying a code block of N consecutive lines of code of a function, where the defined region can also include X1 consecutive lines of code immediately prior to (consecutively before) the code block and/or X2 consecutive lines of code immediately subsequent to (consecutively following) the code block. In this manner in at least one embodiment, the defined region can denote a region of consecutive lines of code of the function formed from i) the code block of modified code, and ii) a surrounding area of consecutive lines of code before and/or after the code block.

The foregoing and other aspects of the techniques of the present disclosure are discussed in more detail in the following paragraphs.

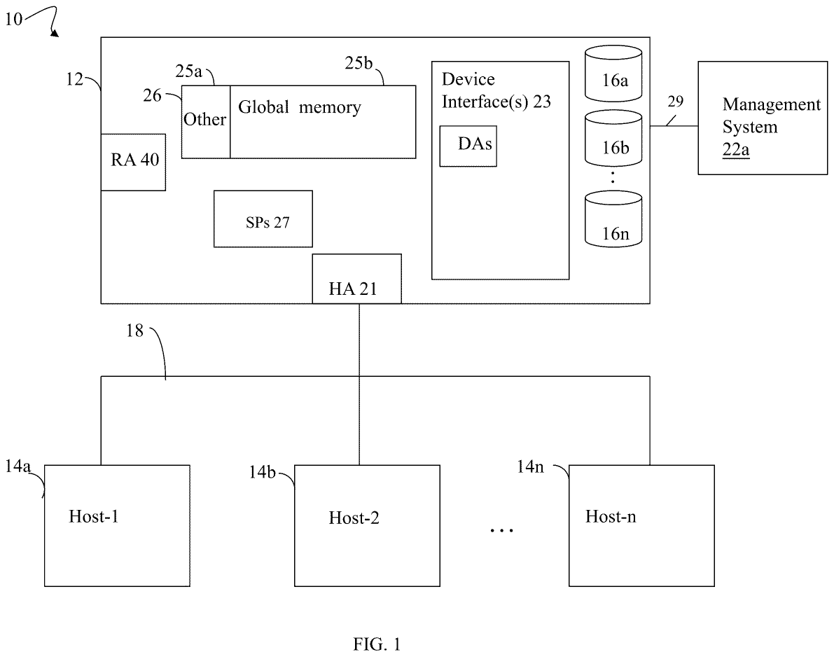

Referring to the FIG. 1, shown is an example of an embodiment of a SAN 10 that is used in connection with performing the techniques described herein. The SAN 10 includes a data storage system 12 connected to the host systems (also sometimes referred to as hosts) 14a-14n through the communication medium 18. In this embodiment of the SAN 10, the n hosts 14a-14n access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, a network, or other wireless or other hardwired connection(s) by which the host systems 14a-14n access and communicate with the data storage system 12, and also communicate with other components included in the SAN 10.

Each of the host systems 14a-14n and the data storage system 12 included in the SAN 10 are connected to the communication medium 18 by any one of a variety of connections as provided and supported in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software included in the data storage system 12 are described herein in more detail, and can vary with each particular embodiment. Each of the hosts 14a-14n and the data storage system 12 can all be located at the same physical site, or, alternatively, be located in different physical locations. The communication medium 18 used for communication between the host systems 14a-14n and the data storage system 12 of the SAN 10 can use a variety of different communication protocols such as block-based protocols (e.g., SCSI, FC, iSCSI, and/or NVMe (Non-Volatile Memory express)), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n issues a data request to the data storage system 12 to perform a data operation. For example, an application executing on one of the host computers 14a-14n performs a read or write operation resulting in one or more data requests to the data storage system 12.

It should be noted that although the element 12 is illustrated as a single data storage system, such as a single data storage array, the element 12 also represents, for example, multiple data storage arrays alone, or in combination with, other data storage devices, systems, appliances, and/or components having suitable connectivity to the SAN 10 in an embodiment using the techniques herein. It should also be noted that an embodiment can include data storage arrays or other components from one or more vendors. In subsequent examples illustrating the techniques herein, reference is made to a single data storage array by a vendor. However, as will be appreciated by those skilled in the art, the techniques herein are applicable for use with other data storage arrays by other vendors and with other components than as described herein for purposes of example.

In at least one embodiment, the data storage system 12 is a data storage appliance or a data storage array including a plurality of data storage devices (PDs) 16a-16n. The data storage devices 16a-16n include one or more types of data storage devices such as, for example, one or more rotating disk drives and/or one or more non-volatile solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contains no moving mechanical parts. In at least one embodiment, the flash devices can be constructed using nonvolatile semiconductor NAND flash memory. The flash devices include, for example, one or more SLC (single level cell) devices, MLC (multi level cell) devices, TLC (triple level cell) devices and/or QLC (quad level cell) devices.

In at least one embodiment, the data storage system or array includes different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs are used to manage communications and data operations between one or more host systems and the global memory (GM). In an embodiment, the HA is a Fibre Channel Adapter (FA) or other adapter which facilitates host communication. The HA 21 can be characterized as a front end component of the data storage system which receives a request from one of the hosts 14a-n. In at least one embodiment, the data storage array or system includes one or more RAs used, for example, to facilitate communications between data storage arrays. The data storage array also includes one or more device interfaces 23 for facilitating data transfers to/from the data storage devices 16a-16n. The data storage device interfaces 23 include device interface modules, for example, one or more disk adapters (DAs) (e.g., disk controllers) for interfacing with the flash drives or other physical storage devices (e.g., PDs 16a-n). The DAs can also be characterized as back end components of the data storage system which interface with the physical data storage devices.

One or more internal logical communication paths exist between the device interfaces 23, the RAs 40, the HAs 21, and the memory 26. An embodiment, for example, uses one or more internal busses and/or communication modules. In at least one embodiment, the global memory portion 25b is used to facilitate data transfers and other communications between the device interfaces, the HAs and/or the RAs in a data storage array. In one embodiment, the device interfaces 23 performs data operations using a system cache included in the global memory 25b, for example, when communicating with other device interfaces and other components of the data storage array. The other portion 25a is that portion of the memory used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n also through the channels. The host systems 14a-n do not address the drives or devices 16a-16n of the storage systems directly, but rather access to data is provided to one or more host systems from what the host systems view as a plurality of logical devices, logical volumes (LVs) also referred to herein as logical units (e.g., LUNs). A logical unit (LUN) can be characterized as a disk array or data storage system reference to an amount of storage space that has been formatted and allocated for use to one or more hosts. A logical unit has a logical unit number that is an I/O address for the logical unit. As used herein, a LUN or LUNs refers to the different logical units of storage referenced by such logical unit numbers. The LUNs have storage provisioned from portions of one or more physical disk drives or more generally physical storage devices. For example, one or more LUNs can reside on a single physical disk drive, data of a single LUN can reside on multiple different physical devices, and the like. Data in a single data storage system, such as a single data storage array, can be accessible to multiple hosts allowing the hosts to share the data residing therein. The HAs are used in connection with communications between a data storage array and a host system. The RAs are used in facilitating communications between two data storage arrays. The DAs include one or more types of device interfaced used in connection with facilitating data transfers to/from the associated disk drive(s) and LUN(s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein.

In an embodiment in accordance with the techniques herein, the data storage system as described can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein are made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a used to manage and monitor the data storage system 12. In one embodiment, the management system 22a is a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration is stored in any suitable data container, such as a database. The data storage system configuration information stored in the database generally describes the various physical and logical entities in the current data storage system configuration. The data storage system configuration information describes, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, data storage system performance information such as regarding various storage objects and other entities in the system, and the like.

Consistent with other discussion herein, management commands issued over the control or management path include commands that query or read selected portions of the data storage system configuration, such as information regarding the properties or attributes of one or more LUNs. The management commands also include commands that write, update, or modify the data storage system configuration, such as, for example, to create or provision a new LUN (e.g., which result in modifying one or more database tables such as to add information for the new LUN), and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN is accessed by the device interface following a data request in connection with I/O operations. For example, a host issues an I/O operation that is received by the HA 21. The I/O operation identifies a target location from which data is read from, or written to, depending on whether the I/O operation is, respectively, a read or a write operation request. In at least one embodiment using block storage services, the target location of the received I/O operation is expressed in terms of a LUN and logical address or offset location (e.g., LBA or logical block address) on the LUN. Processing is performed on the data storage system to further map the target location of the received I/O operation, expressed in terms of a LUN and logical address or offset location on the LUN, to its corresponding physical storage device (PD) and location on the PD. The DA which services the particular PD performs processing to either read data from, or write data to, the corresponding physical device location for the I/O operation.

It should be noted that an embodiment of a data storage system can include components having different names from that described herein but which perform functions similar to components as described herein. Additionally, components within a single data storage system, and also between data storage systems, can communicate using any suitable technique described herein for exemplary purposes. For example, the element 12 of the FIG. 1 in one embodiment is a data storage system, such as a data storage array, that includes multiple storage processors (SPs). Each of the SPs 27 is a CPU including one or more “cores” or processors and each have their own memory used for communication between the different front end and back end components rather than utilize a global memory accessible to all storage processors. In such embodiments, the memory 26 represents memory of each such storage processor.

Generally, the techniques herein can be used in connection with any suitable storage system, appliance, device, and the like, in which data is stored. For example, an embodiment can implement the techniques herein using a midrange data storage system as well as a higher end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path is the logical flow through hardware and software components or layers in connection with issuing data storage management command to and/or from a data storage system, and also receiving responses (possibly including requested data) to such control or management commands. For example, with reference to the FIG. 1, the control commands are issued from data storage management software executing on the management system 22a to the data storage system 12. Such commands, for example, establish or modify data services, provision storage, perform user account management, and the like. Consistent with other discussion herein, management commands result in processing that can include reading and/or modifying information in the database storing data storage system configuration information.

The data path and control path define two sets of different logical flow paths. In at least some of the data storage system configurations, at least part of the hardware and network connections used for each of the data path and control path differ. For example, although both control path and data path generally use a network for communications, some of the hardware and software used can differ. For example, with reference to the FIG. 1, a data storage system has a separate physical connection 29 from a management system 22a to the data storage system 12 being managed whereby control commands are issued over such a physical connection 29. However, user I/O commands are never issued over such a physical connection 29 provided solely for purposes of connecting the management system to the data storage system. In any case, the data path and control path each define two separate logical flow paths.

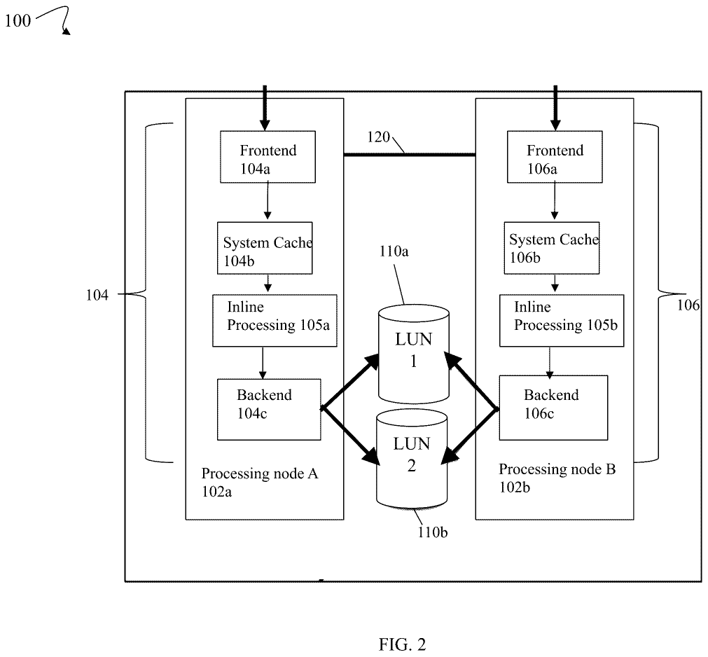

With reference to the FIG. 2, shown is an example 100 illustrating components that can be included in the data path in at least one existing data storage system in accordance with the techniques of the present disclosure. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes, or more generally I/Os, directed to the LUNs 110a, 110b can be received for processing by either of the nodes 102a and 102b, the example 100 illustrates what can also be referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2 is an internal network interconnect 120 between the nodes 102a, 102b. In at least one embodiment, the interconnect 120 can be used for internode communication between the nodes 102a, 102b.

In connection with at least one embodiment in accordance with the techniques of the present disclosure, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM used as main memory. The processor cache can be substantially faster than the system RAM used as main memory. The processor cache can contain information that the processor will be immediately and repeatedly accessing. The faster memory of the CPU cache can for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations. Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be generally as described and represented as the nodes 102a-b in the FIG. 2. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment. Additional software components can be included in the system software stack and can also execute in the context of a VM of the virtualized environment.

In at least one embodiment, each pair of nodes can be configured in an active-active configuration as described elsewhere herein, such as in connection with FIG. 2, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes are not shared with other pairs of nodes. A host can access data stored on a BE PD through the node pair associated with or attached to the PD.

In at least one embodiment, each pair of nodes provides a dual node architecture where both nodes of the pair can be generally identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

In at least one embodiment, the techniques of the present disclosure can be utilized to test code that executes in a data storage system. For example, the code executed in the data storage system can be, for example, code included in the data path or I/O path of functions, routines or code modules executed in connection with I/O processing for I/Os received, for example, from hosts or data storage clients.

In at least one embodiment, the tests can be executed in a data storage system including a simulated data storage system backend (BE). In at least one embodiment, the simulated data storage system BE can include software that simulates BE components of the storage system and simulates the use of such BE components such as in connection with I/O processing. For example, the BE storage devices or drives, configured LUNs or volumes to which host or client I/Os are directed, and the like, can be simulated rather than require the actual underlying hardware components for testing purposes. In at least one embodiment, operations of the data path or I/O path such as, for example, performed in connection with I/Os issued to the simulated BE storage devices or drives, can also be simulated. In this manner in at least one embodiment, the software testing can be very efficient and cost-effective without requiring the underlying hardware to test multiple variants for multiple platforms that can each have different hardware components and configurations.

Although the techniques of the present disclosure can be utilized for testing in a data storage system and testing code of the data path or I/O path with a simulated data storage system BE, the techniques of the present disclosure can more generally be used in connection with testing code of any suitable system, product or application.

In at least one embodiment, any suitable code coverage tools can be used to provide code coverage and analysis information in connection with the test runs. In at least one embodiment, the code coverage and analysis information can include i) function or routine coverage identifying the particular functions or routines called, invoked or executed during a test run; and ii) the number of times each function or routine is invoked during a test run.

In at least one embodiment, the techniques of the present disclosure can be used to determine tests relevant to a code change. In at least one embodiment, the relevance of a test to the code change can be determined based on i) the function coverage provided by the test, and ii) whether there are other prior code changes in a same area of code where the code change is made. In at least one embodiment, each of the other prior code changes can be made in the same area of code to correct a prior bug or error. In at least one embodiment, the area of code can be determined based, at least in part, on the particular lines of code modified by the code change. In at least one embodiment, the area of code can at least include the particular lines of code. In at least one embodiment, the area of code can be optionally further expanded to also include additional surrounding lines of code. For example, the area of code can include a specified number of additional consecutive lines of code occurring immediately before and/or after a consecutive block of one or more of the particular lines of code.

In at least one embodiment, a test-to-function footprint (sometimes simply referred to as a footprint) can be used to select the tests that can exercise or cover the functions modified by a code change such as of a pull or modify request.

In at least one embodiment, the footprint can be a table where each row corresponds to a test, each column corresponds to a function, and each table entry or cell includes a corresponding vector or array of function hits or counts. Each table entry or cell can be associated with a particular test and a particular function. The vector of the table cell includes vector entries, where each vector entry corresponds to a different platform upon which the particular test can be executed, and where the vector entry of a respective platform denotes a number of times the particular function is called when the particular test is executed on the respective platform.

Referring to FIG. 3A, shown is an example 200 of a footprint implemented as a table in at least one embodiment in accordance with the techniques of the present disclosure.

The table 200 is illustrated with respect to a particular number of tests, functions and platforms for simplicity. More generally, the table or footprint can be constructed with any suitable number of tests, functions and platforms that can vary with embodiment.

The table 200 is illustrated with respect to i) 3 functions—Func A, Func B and Func C; and ii) 4 tests—Test A, Test B, Test C and Test D. Consistent with discussion above, i) the number of functions can correspond to the number of columns of the table 200, and ii) the number of tests can correspond to the number of rows of the table 200. Thus in this example, the table 200 includes: i) 3 columns 202a-c each of which corresponds to a different one of the 3 functions; and ii) 4 rows 204a-d each of which corresponds to a different one of the 4 tests. In particular, the columns 202a-c respectively correspond to Func A, Func B and Func C; and the rows 204a-d respectively correspond to Test A, Test B, Test C and Test D.

Each cell or table entry of the table 200 includes a vector or array of 4 integer values corresponding to 4 platforms upon which each test can be run. In this example, assume the 4 platforms are Platform A, Platform B, Platform C, and Platform D. Each vector entry of a table entry corresponds to a respective one of the foregoing 4 platforms and denotes a count of the number of times a corresponding function is invoked when executing a test corresponding to the table entry on the respective platform. In particular, from left to right positioning, the vector entries of each vector included in a table entry can denote function hits or counts respectively for Platform A, Platform B, Platform C, and Platform D.

To further illustrate, the table entry 206a corresponds to the Test A 204a and Func A 202a and includes the vector “0/1/10/1” indicating that i) when Test A is run on Platform A, Func A is called or invoked 0 times (as denoted by the first vector entry of 206a); ii) when Test A is run on Platform B, Func A is called or invoked 1 time (as denoted by the second vector entry of 206a; iii) when Test A is run on Platform C, Func A is called or invoked 10 times (as denoted by the third vector entry of 206a); and iv) when Test A is run on Platform D, Func A is call or invoked 1 time (as denoted by the fourth vector entry of 206a).

The table entry 206b corresponds to the Test B 204b and Func A 202a and includes the vector “1000/10/10/1” indicating that i) when Test B is run on Platform A, Func A is called or invoked 1000 times (as denoted by the first vector entry of 206b); ii) when Test B is run on Platform B, Func A is called or invoked 10 times (as denoted by the second vector entry of 206b; iii) when Test B is run on Platform C, Func A is called or invoked 10 times (as denoted by the third vector entry of 206b); and iv) when Test B is run on Platform D, Func A is call or invoked 1 time (as denoted by the fourth vector entry of 206b).

The table entry 206c corresponds to the Test C 204c and Func A 202a and includes the vector “0/0/0/0” indicating that when Test A is run on any of the 4 Platforms A-D, Func A is called or invoked 0 times (as denoted by all vector entries of 206c being 0).

The table entry 206d corresponds to the Test D 204a and Func A 202a and includes the vector “100/100/100/100” indicating that i) when Test A is run on any of the 4 Platforms A-D, Func A is called or invoked 100 times (as denoted by all vector entries of 206c being 100).

The table entry 208a corresponds to the Test A 204a and Func B 202b and includes the vector “0/1/10/1” indicating that i) when Test A is run on Platform A, Func B is called or invoked 0 times (as denoted by the first vector entry of 208a); ii) when Test A is run on Platform B, Func B is called or invoked 1 time (as denoted by the second vector entry of 208a; iii) when Test A is run on Platform C, Func B is called or invoked 10 times (as denoted by the third vector entry of 208a); and iv) when Test A is run on Platform D, Func B is call or invoked 1 time (as denoted by the fourth vector entry of 208a).

The table entry 208b corresponds to the Test B 204b and Func B 202b and includes the vector “0/0/0/0” indicating that when Test B is run on any of the 4 Platforms A-D, Func B is called or invoked 0 times (as denoted by all vector entries of 208b being 0).

The table entry 208c corresponds to the Test C 204c and Func B 202b and includes the vector “0/0/0/0” indicating that when Test C is run on any of the 4 Platforms A-D, Func B is called or invoked 0 times (as denoted by all vector entries of 208c being 0).

The table entry 208d corresponds to the Test D 204a and Func B 202b and includes the vector “10/0/0/0” indicating that i) when Test D is run on Platform A, Func B is called or invoked 10 times (as denoted by the first vector entry of 208d); and ii) when Test D is run on any of Platforms B, C or D, Func B is called or invoked 0 times (as denoted respectively by the second, third and fourth vector entries of 208d).

The table entry 210a corresponds to the Test A 204a and Func C 202c and includes the vector “0/1/10/1” indicating that i) when Test A is run on Platform A, Func C is called or invoked 0 times (as denoted by the first vector entry of 210a); ii) when Test A is run on Platform B, Func C is called or invoked 1 time (as denoted by the second vector entry of 210a; iii) when Test A is run on Platform C, Func C is called or invoked 10 times (as denoted by the third vector entry of 210a); and iv) when Test A is run on Platform D, Func C is call or invoked 1 time (as denoted by the fourth vector entry of 210a).

The table entry 210b corresponds to the Test B 204b and Func C 202c and includes the vector “0/0/10/10” indicating that i) when Test B is run on Platform A, Func C is called or invoked 0 times (as denoted by the first vector entry of 210b); ii) when Test B is run on Platform B, Func C is called or invoked 0 times (as denoted by the second vector entry of 210a); iii) when Test B is run on Platform C, Func C is called or invoked 10 times (as denoted by the third vector entry of 210b); and iv) when Test B is run on Platform D, Func C is call or invoked 10 times (as denoted by the fourth vector entry of 210b).

The table entry 210c corresponds to the Test C 204c and Func C 202c and includes the vector “0/0/100/0” indicating that i) when Test C is run on Platform A, Func C is called or invoked 0 times (as denoted by the first vector entry of 210c); ii) when Test C is run on Platform B, Func C is called or invoked 0 times (as denoted by the second vector entry of 210c); iii) when Test C is run on Platform C, Func C is called or invoked 100 times (as denoted by the third vector entry of 210c); and iv) when Test C is run on Platform D, Func C is call or invoked 0 times (as denoted by the fourth vector entry of 210c).

The table entry 210d corresponds to the Test D 204d and Func C 202c and includes the vector “0/0/0/0” indicating that when Test D is run on any of the 4 Platforms A-D, Func D is called or invoked 0 times (as denoted by all vector entries of 210d being 0).

What will now be described with reference to FIG. 3B is a flowchart 230 of steps that can be performed in at least one embodiment to construct or generated the test to function footprint of FIG. 3A in at least one embodiment in accordance with the techniques of the present disclosure.

In the step 232, for a particular software system, application or product under test, run each test individually on each platform using the system, application or product under test. Optionally, each test can be run multiple times on one or more of the platforms using the system, application or product under test in order to take into account, for example, any randomness or possible variations in test runtime or execution flow.

From the step 232 control proceeds to the step 234.

At the step 234, for each test run on each platform using the system, application of product under test, performing processing to determine testing coverage information for the test run on the platform.

In at least one embodiment, any suitable test coverage and/or analysis tools can be used to generate the testing coverage information.

In at least one embodiment the testing coverage information can include function invocation or call information identifying which functions of the system or product undertest are called or invoked and a count of the number of times each function is called or invoked.

In at least one embodiment, if a test run is repeated or performed multiple times as optionally noted above, the count can denote an average of the number of calls or invocation of each function with respect to the multiple times the test run is repeated. For example if a test is run3 times on platform A and Func A is called 3, 4 and 5 times, respectively on each of the 3 test runs, then count can be 4 for the foregoing based on the average of 3, 4 and 5.

The foregoing can be performed for each test on all platforms. From the step 234, control proceeds to the step 236.

At the step 236, the table denoting the footprint can be generated using the function invocation or call information obtained in the step 234.

In at least one embodiment using a table as illustrated in FIG. 3A, the count N1 determined for a particular function X1 executed on a particular platform X2 when running a particular test X3 can be used to populate a vector entry or array entry corresponding to the platform X2 of the table entry or cell located at row R1, column C1, where R1 corresponds to test X1 and where C1 corresponds to function X1. For example with reference back to the row 204b of FIG. 3A, the Test B can be run in the software system or product under test on Platform A where it is observed that Func A is called 1000 times (220a), Func B is called 0 times (220b) and Func C is called 0 times (220c).

Before describing in further detail use of the footprint in at least one embodiment, what will now be described are additional structures or components that can be used in at least one embodiment in accordance with the techniques of the present disclosure.

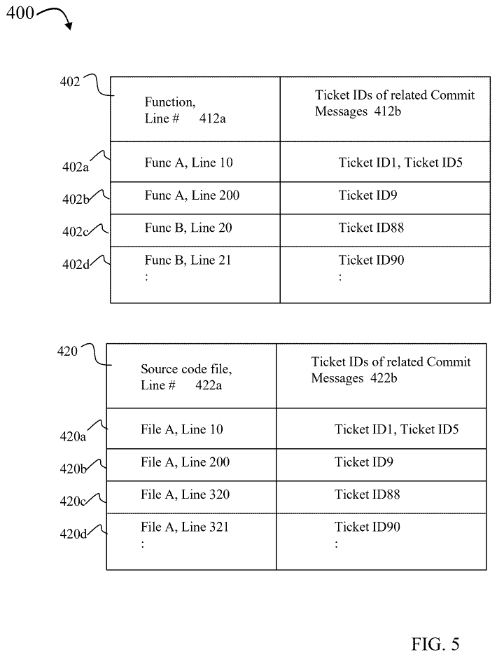

Referring to FIG. 4, shown is an example of 300 illustrating a pull or modify request and a ticket database that can be used in at least one embodiment in accordance with the techniques of the present disclosure.

Consistent with other discussion herein, a pull or modify request 302 can be created in connection with an SCS or source code control system when a developer or other user desires to check in and merge their local set or version of code changes with an existing main version of a code base of a software system, application or product. The request 302 can generally include one or more commit messages 302a, 302b. Each of the commit messages such as 302a can record source code changes to one or more files and one or more functions, where such source code changes can be included in the developer's version or branch of code. Thus a commit message can represent a snapshot of code changes at a specific time providing a historical record of code development over time. In at least one embodiment, there can be source code of one or more functions or routines in each source file.

The element 310 illustrates in more detail information that can be included in each of the commit messages such as commit message 302a of the request 302. The commit message 302a can include: the source code changes 310a; the source file(s) and source file line number(s) of the source code changes 310b; the function(s) and function line number(s) corresponding to the source code changes (310a) of the commit 310c; and a ticket ID or identifier 310d corresponding to the source code changes (310a).

In at least one embodiment, the source code changes 310a can denote the actual source code modifications, changes or additions made.

In at least one embodiment, each commit message can correspond to a set of code changes corresponding to a single ticket ID. Each ticket ID can correspond uniquely to a single set of code changes for a particular purpose. For example, in at least one embodiment, each single commit message and corresponding ticket ID can uniquely correspond to code changes for any of: i) a particular bug fix for a software error or problem report; or ii) a new feature added to the software. In at least one embodiment, a ticket ID can have a corresponding prefix portion to denote the particular types or categories tickets. For example, a ticket ID can have a corresponding prefix portion ABC if the ticket ID denotes a code change for a bug fix; and can have a different corresponding prefix portion XYZ if the ticket ID denotes a code change for a new feature rather than a bug fix.

Although 310 is illustrated as more detail with respect to commit message 302a, more generally, each commit message of the request 302 can include information similar to 310.

In at least one embodiment, the ticket ID of each commit message can be used as an index into the ticket database 330. Generally, the ticket database 330 can include additional information related to each ticket ID and its corresponding source code changes.

In at least one embodiment, the ticket database 330 can include ticket IDs 330a and corresponding testing information 330b. For each ticket ID, the testing information can include the following information illustrated by the element 340: the type or category of code change 340a such as either i) a defect or bug fix or ii) a new feature; identify the one or more tests that failed 340b; and for each failed test listed in 340b, the one or more platforms upon which the particular test that failed is executed 340c.

Thus based on the above, the information of 340b and 340c can be included if the code change 340a is for a bug fix or source code change made to correct a software bug or error.

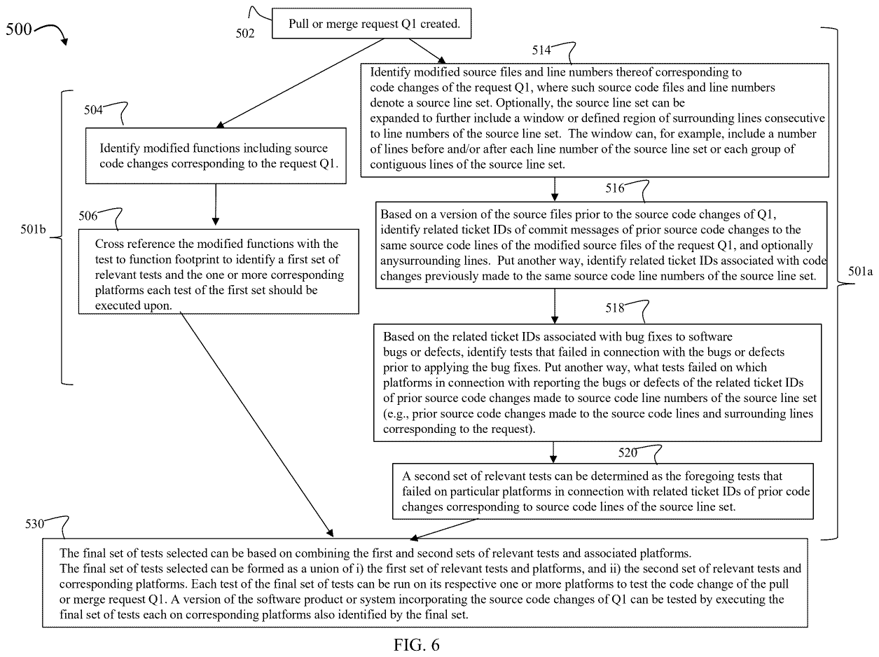

Referring to FIG. 5, shown is an example 400 of libraries or catalogues of ticket IDs denoting source code changes made to particular functions and source files.

The element 402 is a first library or catalogue of information identifying particular lines numbers of functions having their respective source code modified by a code change of a corresponding ticket ID. Put another way, each line of the first catalogue 402 identifies a particular function and function line number (412a) and the ticket IDs (412b) of source code changes that modify the particular function line number of the function (412a).

Consistent with discussion above, each ticket ID is associated with a commit message that introduces or makes a code change to one or more lines of a corresponding function. A line number L1 of the function F1 can correspond to a row R1 of the first catalogue 402, where R1 can also identify the ticket IDs of source code changes that modified the line number L1 of the function F1.

To illustrate with reference to 402 which is indexed by function and function line number (412a), the row 402a indicates that the source code of Func A line 10 is modified by code changes of ticket ID1 and ID5; the row 402b indicates that the source code of Func A line 200 is modified by code changes of ticket ID 9; the row 402c indicates that the source code of Func B line 20 is modified by code changes of ticket ID 88; and the row 402d indicates that the source code of Func B line 21 is modified by code changes of ticket ID 90.

As a variation of, or in addition to, the first catalogue 402, an embodiment can use a second catalogue 420 which indexes ticket IDs of related commit messages by source code file and source code line number 422a rather than function and function line number 412. Put another way, the information of columns 412b and 422b can be the same but can be accessed using either the relevant function and function line number 412a using the catalogue 402 or alternatively using the relevant source code file name and source code line number 422a using the catalogue 420.

To illustrate with reference to 420 which is indexed by source code file and source code file line number (422a), the row 422a indicates that the source code of source file File A line 10 is modified by code changes of ticket ID1 and ID5; the row 422b indicates that the source code of source File A line 200 is modified by code changes of ticket ID 9; the row 422c indicates that the source code of the source File A line 320 is modified by code changes of ticket ID 88; and the row 432d indicates that the source code of the source File A line 321 is modified by code changes of ticket ID 90.

In at least one embodiment, a first set of tests can be selected to run or execute on particular platforms for testing purposes for a source code change of a software product, system or application using the footprint of FIG. 3A. Generally, a modified function set M1 of one or more functions modified by the source code change can be determined. The changed or modified functions of M1 can be cross-referenced with the footprint to determine the first set of tests. Using the footprint, a test can be determined as relevant to a modified function of M1 if the column of the footprint corresponding to the modified function has one or more non-zero counts or function hits across the platforms and functions (e.g., if any function on any platform is executed one or more times when the test is executed using the software product, application or system. The foregoing is described in more detail below with reference to FIG. 3A.

For example, assume that a pull or modify request modifies Func B and Func C. For Func B, the column 202b can be examined for those table entries 208a and 208d that contain non-zero vector entries. In particular, the table entry 208a corresponds to running the Test A, where the table entry 208a is “0/1/10/1” indicating that Test A should be executed on Platforms B, C, and D. The table entry 208d corresponds to running the Test D, where the table entry 208d is “10/0/0/0” indicating that Test D should be executed on only Platform A.

For Func C, the column 202c can be examined for those table entries 210a-c that contain non-zero vector entries. In particular, the table entry 210a corresponds to running the Test A, where the table entry 210a is “0/1/10/1” indicating that Test A should be executed on Platforms B, C, and D. The table entry 210b corresponds to running the Test B, where the table entry 210b is “0/0/10/10” indicating that Test B should be executed on only Platforms C and D. The table entry 210c corresponds to running the Test C, where the table entry 210c is “0/0/100/0” indicating that Test C should be executed on only Platform C.

Based on the foregoing non-zero table entries 280a, 208d, 210a, 210b and 210c, in summary for a source code change that modifies Func B and Func C based on the footprint of FIG. 3A, the test selection of the first set can be determined as:
1) Run Test A on Platform B, Platform C, and Platform D
2) Run Test B on Platform C and Platform D
3) Run Test C on Platform C
4) Run Test D on Platform A

In at least one embodiment, a second set of tests can be selected to run or execute on particular platforms for testing purposes for a source code change CH1 of a software product, system or application based on a history of related code changes. In particular, for a first code change CH1 to a first line L1 of code, other related code changes CH2 to the same first line L1 of code can be determined, where each other related code change CH2 can have a corresponding ticket ID which can be used to identify other tests TSTS that failed when executed on particular platforms PL prior to applying code change CH2. In at least one embodiment, the other tests TSTS of CH2 can be added to the second set of tests to be used in connection with testing the current first source code change CH1 where the other tests TSTS can be executed on the previously failed platforms PL in connection with testing the first source code change CH1.

In at least one embodiment, the area or region of source code examined to determine related code changes CH2 and respective ticket IDs can include i) the one or more lines of code modified in the first code change CH1; and ii) can be optionally expanded to include one or more surrounding lines of code. In at least one embodiment, the one or more surrounding lines of code can be a set of contiguous or consecutive lines of code that can occur immediately before and/or after a block of one or more consecutive lines of code of the first code change CH1. For example, the first code change CH1 can be made to lines 100-110 consecutive lines of code of source file FILE1 forming the block of code. The area or region of code examines to determined related code changes and respective ticket IDs can be expanded to further include 10 lines before and 10 lines after the block of code whereby the area or region can be formed from lines 90-120 of FILE 1.

In at least one embodiment, the second set of tests can be determined as follows. In a step S1, the pull or modify request, or more generally first code changes, can be analyzed to determine which lines of code are modified. In at least one embodiment, the lines of code modified by the first code changes can be with respect to source code file and source code file line numbers. Following the step S1, a step S2 can be performed.

In the step S2, the area or region R1 of source code examined to determine related other prior code changes can be determined. The region R1 can include the one or more lines of code modified in the first code changes; and ii) can be optionally expanded to include one or more surrounding lines of code. In at least one embodiment, the one or more surrounding lines of code can be a set of contiguous or consecutive lines of code that can occur immediately before and/or after a block of one or more consecutive lines of code of the first code changes. Following the step S2, a step S3 can be performed.

In the step S3, processing can identify ticket IDs of other prior code changes that also modified lines of code in the area or region R1. In at least one embodiment, the step S3 can use the catalogue 420 of FIG. 5 to lookup each source code line of the region R1 and obtain any related ticket IDs of prior code changes that modified the source code line. For example with reference to FIG. 5, the region R1 can include source code File A, line 10, where the step S3 can include indexing into the catalogue 420 to the line 420a where related ticket IDs 1 and 5 are determined. Following the step S3, a step S4 can be performed.

In the step S4, each of the related ticket IDs can be used to index into the ticket database 330 to determine corresponding testing information 330b. For example, ticket ID1 can be used to index into the database 330 to identify i) the one or more tests that failed 340b and ii) for each failed test, the one or more platforms upon which the test was executed. Following the step S4 is a step S5.

In the step S5, the second set of tests can be formed from the failed test and corresponding platforms upon which to run such tests as identified in the step S4 for each of the related ticket IDs.

The foregoing uses source code files and source code file lines numbers to denote the particular lines of code that are modified using the catalogue 420. In at least one embodiment, code changes can be expressed in terms of functions and function line numbers rather than source code files and source code file line numbers. In this latter embodiment, the above-noted steps S1-S5 can be modified in a straightforward manner to user functions and function line numbers and the catalogue 402 (rather than the catalogue 420).

If a new test is added, a new row can be added to the table of the footprint such as added to the table of FIG. 3A. To add the new row of information, coverage information can be determined for new test in a manner similar to that as previously performed and described in connection with initially generating the footprint such as, for example, performing the processing steps of FIG. 3B. The new test can be run individually on each platform and corresponding coverage information can be generated. The coverage information can denote, for each platform, which functions are executed or how many times each function is executed when running the new test on the platform.

If a new function is added to a source code file, a corresponding new column can be added to the table of the footprint, such as added to the table of FIG. 3A. To generate information used to populate the new column, all tests can be run on all platforms and corresponding coverage information can be generated to determine which tests cover the new function. The coverage information for each test can denote, for each platform on which the test is run, a count of the number of times the new function is called or executed during the test run. For example, assume the existing functions include functions A, B and C and the entire suite of all existing tests are Tests A, B C and D. Now a new function D is added and the code base and corresponding information for new function D needs to be added to the footprint as a new column to the table. To obtain the footprint information for function D, each of the existing tests A, B C and D is executed on all the platforms to determine which of the foregoing existing tests covers, calls or executes code of the new function D.

When a new function is added such as in a pull request, the footprint does not include information about which tests exercise or cover that new function. As a result in at least one embodiment, a fallback or default testing option can be used to initially test the new function. In at least one embodiment, the default testing option can be, for example, to execute a predetermined set of existing tests that can be used to initially test and verify or validate the new function. Subsequently, the footprint can be accordingly updated as noted above to include footprint information for the new function.

Referring to FIG. 6, shown is a flowchart 500 of processing that can be performed in at least one embodiment in accordance with the techniques of the present disclosure. The step of FIG. 6 summarize processing described above.

The steps 502, 504 and 506 summarize a first processing flow described above in connection with determining the first set of tests and corresponding platforms upon which to execute tests of the first set.

The steps 502, 514, 516, 518 and 520 summarize a second processing flow described above in connection with determining the second set of tests and corresponding platforms upon which to execute tests of the second set.

In at least one embodiment, after determining the first and second sets of tests and corresponding platforms, a final set of tests selected for testing can be based on combining the first and second sets.

At the step 502, a pull or merge request Q1 can be created where R1 includes source code changes. With the first processing flow, control proceeds from the step 502 to the step 504.

At the step 504, processing identifies modified functions including the source code changes of the request Q1. From the step 504, control proceeds to the step 506.

At the step 506, processing can be performed to cross reference the modified functions with the test to function footprint to identify the first set of relevant tests and the one or more corresponding platforms each test of the first set should be executed upon. From the step 506, control proceeds to the step 530.

With the second processing flow, control proceeds from the step 502 to the step 514.

At the step 514, processing can identify modified source files and line numbers thereof corresponding to code changes of the request Q1, where such source code files and line numbers denote a source line set. Optionally, the source line set can be expanded to further include a window or defined region of surrounding lines consecutive to line numbers of the source line set. The window can, for example, include a number of lines before and/or after each line number of the source line set or each group of contiguous lines of the source line set. The source line set can correspond, for example, the source code line number of the region R1 of the step S2 above. From the step 514, control proceeds to the step 516.

At the step 516, based on a version of the source files prior to the source code changes of Q1, processing can identify related ticket IDs of commit messages of prior source code changes to the same source code lines of the modified source files of the request Q1, and optionally any surrounding lines. Put another way, identify related ticket IDs associated with code changes previously made to the same source code line numbers of the source line set or region R1. From the step 516, control proceeds to the step 518.

At the step 518, based on the related ticket IDs associated with bug fixes to software bugs or defects, identify tests that failed in connection with the bugs or defects prior to applying the bug fixes. Put another way, what tests failed on which platforms in connection with reporting the bugs or defects of the related ticket IDs of prior source code changes made to source code line numbers of the source line set (e.g., prior source code changes made to the source code lines and surrounding lines corresponding to the request). From the step 518, control proceeds to the step 520.

At the step 520, the second set of relevant tests can be determined as the foregoing tests identified in the step 518 that failed on particular platforms in connection with related ticket IDs of prior code changes corresponding to source code lines of the source line set or the region R1.

From the step 520 control proceeds to the step 530.

Once i) the step 506 completes and the first set of tests and platforms is determined; and ii) the step 520 completes and the second set of tests and platforms is determined, control proceeds to the step 530.

At the step 530, processing can determine the final set of tests selected based on the first and second sets of relevant tests and associated platforms. In at least one embodiment, the final set of tests selected can be formed as a union (e.g., set union operation) of i) the first set of relevant tests and platforms, and ii) the second set of relevant tests and corresponding platforms. Each test of the final set of tests can be run on its respective one or more platforms to test the code change such as the code change of the pull or merge request Q1. The source code changes of Q1 can be made with respect to a software products, system or application. A version of the software product or system incorporating the source code changes of Q1 can be tested by executing the final set of tests each on corresponding platforms also identified by the final set.

In at least one embodiment, the source code changes of Q1 can be validated or verified if all tests of the final set executed on corresponding platforms successfully. Responsive to all tests of the final set executing successfully, the source code changes of Q1 can be merged or incorporated into a main branch or version of the software product made available to other developers.

Consistent with other discussion above, the second flow 501b can also be performed where the source code changes are denoted using functions and function line numbers rather than source code files and source code file line numbers.

In at least one embodiment, processing can perform both the above noted first flow 501a and second flow 501b. In at least one embodiment, both such flows 501a-b can be performed in parallel. As a variation, in at least one embodiment the flows 501a and 501b can be performed sequentially in any suitable ordering.

As a variation, an embodiment in accordance with the techniques of the present disclosure can determine or select the tests to run based, at least in part, on the workflow 501a without performing workflow 501b. As yet another variation, an embodiment in accordance with the techniques of the present disclosure can determine or select the tests to run based, at least in part, on the workflow 501b without performing the workflow 501a.

The techniques herein can be performed by any suitable hardware and/or software. For example, techniques herein can be performed by executing code which is stored on any one or more different forms of computer-readable media, where the code can be executed by one or more processors, for example, such as processors of a computer or other system, an ASIC (application specific integrated circuit), and the like. Computer-readable media can include different forms of volatile (e.g., RAM) and non-volatile (e.g., ROM, flash memory, magnetic or optical disks, or tape) storage which can be removable or non-removable.

While the techniques of the present disclosure have been presented in connection with embodiments shown and described in detail herein, their modifications and improvements thereon will become readily apparent to those skilled in the art. Accordingly, the spirit and scope of the techniques of the present disclosure should be limited only by the following claims.

What is claimed is:

1. A computer-implemented method comprising:
receiving first source code changes that modify first functions, wherein the first functions are included a plurality of functions;
cross referencing the first functions with a footprint to identify a first test set, wherein the footprint indicates which of the plurality of functions are executed by each test of a plurality of tests when said each test is executed on a plurality of platforms, wherein the first test set includes a first portion of the plurality of tests, and wherein each test of the first portion, when executed on one or more of the plurality of platforms, executes at least one function included in the first functions;
determining a region of code based, at least in part, on the first source code changes;
determining other source code changes that modify one or more lines of code included in the region of code;
determining a second test set based, at least in part, on the other source code changes, where the second test set includes a second portion of the plurality of tests, and wherein each test of the second portion when executed on one or more of the plurality of platforms failed prior to making a corresponding one or more of the other source code changes;
determining a final test set based on the first test set and the second test set; and
testing the first source code changes by executing the final test set using a first version of a software product including the first source code changes.

2. The computer-implemented method of claim 1, wherein the footprint includes a table, wherein each column of the table corresponds to one of the plurality of functions, wherein each row of the table corresponds to one of the plurality of tests, and wherein each entry of the table includes a vector with a plurality of vector entries each corresponding to one of the plurality of platforms.

3. The computer-implemented method of claim 2, wherein a vector entry of the vector of said each entry of the table includes a non-zero value if a corresponding test executed on a corresponding platform executed code of a corresponding function, and wherein the corresponding test and the corresponding function correspond uniquely to said each entry of the table including the vector.

4. The computer-implemented method of claim 3, wherein the non-zero value denotes a count of the number of times the corresponding function is called when executing the corresponding test on the corresponding platform.

5. The computer-implemented method of claim 2, wherein a vector entry of the vector of said each entry of the table includes a zero value if a corresponding test executed on a corresponding platform did not execute code of a corresponding function, and wherein the corresponding test and the corresponding function correspond uniquely to said each entry of the table including the vector.

6. The computer-implemented method of claim 1, wherein the software product includes software of a data path used to process I/O operations received at a data storage system.

7. The computer-implemented method of claim 1, wherein the first source code changes are included in a first request to merge the first source code changes with a main version of the software product.

8. The computer-implemented method of claim 7, further comprising:
determining whether all tests of the final test set executed successfully; and
responsive to determining that all tests of the final test set executed successfully against the first version of the software product, merging the first source code changes with the main version of the software product.

9. The computer-implemented method of claim 1, wherein the first source code changes modify a first set of lines of code, wherein the region of code includes the first set of lines of code.

10. The computer-implemented method of claim 9, wherein the region of code further includes a window of code based, at least in part, on one or more lines of code of the first set.

11. The computer-implemented method of claim 10, wherein the window of code includes a specified number of consecutive lines of code which are i) prior to the one or more lines of code, and ii) contiguous with the one or more lines of code in any of a source file or a same function.

12. The computer-implemented method of claim 10, wherein the window of code includes a specified number of consecutive lines of code which are i) after the one or more lines of code, and ii) contiguous with the one or more lines of code in any of a source file or a same function.

13. The computer-implemented method of claim 1, wherein the other source code changes are associated with respective ticket identifiers corresponding to source code changes made to correct software errors.

14. The computer-implemented method of claim 1, further comprising:
executing each of the plurality of tests each on each of the plurality of platforms;
obtaining first coverage information based, at least in part, on the said executing, wherein the first coverage information includes information identifying, for each of the plurality of tests executed on each of the plurality of platforms, which of the plurality of functions is called as a result of executing said each test on said each platform; and
generating the footprint based, at least in part, the first coverage information.

15. The computer-implemented method of claim 1, wherein the region of code is expressed using source code files and source code file line numbers, and wherein the other source code changes are also expressed using source code files and source code file line numbers.

16. The computer-implemented method of claim 1, wherein the region of code is expressed using functions and function line numbers, and wherein the other source code changes are also expressed using functions and function line numbers.

17. A system comprising:
one or more processors; and
one or more memories comprising code stored thereon that, when executed, performs a method comprising:
receiving first source code changes that modify first functions, wherein the first functions are included a plurality of functions;
cross referencing the first functions with a footprint to identify a first test set, wherein the footprint indicates which of the plurality of functions are executed by each test of a plurality of tests when said each test is executed on a plurality of platforms, wherein the first test set includes a first portion of the plurality of tests, and wherein each test of the first portion, when executed on one or more of the plurality of platforms, executes at least one function included in the first functions;
determining a region of code based, at least in part, on the first source code changes;
determining other source code changes that modify one or more lines of code included in the region of code;
determining a second test set based, at least in part, on the other source code changes, where the second test set includes a second portion of the plurality of tests, and wherein each test of the second portion when executed on one or more of the plurality of platforms failed prior to making a corresponding one or more of the other source code changes;
determining a final test set based on the first test set and the second test set; and
testing the first source code changes by executing the final test set using a first version of a software product including the first source code changes.

18. One or more non-transitory computer readable media comprising code stored thereon that, when executed, perform a method comprising:
receiving first source code changes that modify first functions, wherein the first functions are included a plurality of functions;
cross referencing the first functions with a footprint to identify a first test set, wherein the footprint indicates which of the plurality of functions are executed by each test of a plurality of tests when said each test is executed on a plurality of platforms, wherein the first test set includes a first portion of the plurality of tests, and wherein each test of the first portion, when executed on one or more of the plurality of platforms, executes at least one function included in the first functions;
determining a region of code based, at least in part, on the first source code changes;
determining other source code changes that modify one or more lines of code included in the region of code;
determining a second test set based, at least in part, on the other source code changes, where the second test set includes a second portion of the plurality of tests, and wherein each test of the second portion when executed on one or more of the plurality of platforms failed prior to making a corresponding one or more of the other source code changes;
determining a final test set based on the first test set and the second test set; and
testing the first source code changes by executing the final test set using a first version of a software product including the first source code changes.

19. The one or more non-transitory computer readable media of claim 18, wherein the footprint includes a table, wherein each column of the table corresponds to one of the plurality of functions, wherein each row of the table corresponds to one of the plurality of tests, and wherein each entry of the table includes a vector with a plurality of vector entries each corresponding to one of the plurality of platforms.

20. The one or more non-transitory computer readable media of claim 19, wherein a vector entry of the vector of said each entry of the table includes a non-zero value if a corresponding test executed on a corresponding platform executed code of a corresponding function, and wherein the corresponding test and the corresponding function correspond uniquely to said each entry of the table including the vector.
